(19) United States
(12) Patent Application Publication
(10) Pub. No.: US 2017/0105041 A1
(43) Pub. Date: Apr. 13, 2017

(54) METHOD AND DEVICE OF INTERACTIVE FUNCTION CARD OF SMART TELEVISION

(71) Applicants: LE HOLDINGS (BEIJING) CO., LTD., Beijing (CN); LE SHI ZHI XIN ELECTRONIC TECHNOLOGY (Tianjin) LIMITED, Tianjin (CN)

(72) Inventors: Shengjie Hu, Tianjin (CN); Min Wang, Tianjin (CN); Bin Xu, Tianjin (CN)

(21) Appl. No.: 15/246,353

(22) Filed: Aug. 24, 2016

Related U.S. Application Data
(63) Continuation of application No. PCT/CN2016/089114, filed on Jul. 7, 2016.

(30) Foreign Application Priority Data
Oct. 13, 2015 (CN) 201510657046.5

(51) Int. Cl. H04N 21/436; H04N 21/472; H04N 21/222; H04N 21/443; H04N 21/658

(52) U.S. Cl. CPC H04N 21/43607; H04N 21/443; H04N 21/6582; H04N 21/2223; H04N 21/472

(57) ABSTRACT

The embodiment of the present disclosure discloses the framework managing method and framework managing device of the interactive function card of the smart television. The framework managing method comprises the following steps of: receiving the card update instruction; downloading the new on-line card from the server according to the downloading instruction when the card update instruction is served as the downloading instruction; receiving the card list startup instruction, starting the card list, wherein the card list includes the plurality of cards, and each card has the corresponding interactive function; receiving the user selection instruction, and operating the corresponding card contained in the card list through the host program.

### CROSS-REFERENCE TO RELATED APPLICATIONS

This application is a continuation of International Application No. PCT/CN2016/089114 filed on Jul. 7, 2016, which is based upon and claims priority to Chinese Patent Application No. 201510657046.5, entitled “FRAMEWORK MANAGING METHOD AND FRAMEWORK MANAGING DEVICE OF INTERACTIVE FUNCTION CARD OF SMART TELEVISION”, filed on Oct. 13, 2015, the entire contents of all of which are incorporated herein by reference.

### TECHNICAL FIELD

The present disclosure relates to the technical field of domestic appliances, and particularly relates to framework managing method and framework managing device of an interactive function card of a smart television.

### BACKGROUND

Large-screen viewing experience has been greatly enhanced due to the generation of the smart television, and the smart television is an amusement center of a family. The smart television is capable of integrating a network resource and provides more functions and services which are specially designed for television program viewing, such as the services of providing program related information, relevant star introduction, relevant videos and the like, so that the viewing experience of users is enhanced.

At present, a television interaction platform is used for providing a program improving service for a video program; the television interaction platform is capable of providing a uniform program content interaction function for a cable television program, a rotating program and an on-demand program. Instantaneity and the relevance of functions and program contents are emphasized in television interaction, and thus the importance of background operation in an interactive function is enhanced to maximum. A plurality of interactive functions are pushed to the users by combining an operating background with a program time point so as to give natural and well-timed experience to the users. In the prior art, the interactive functions of newly increased applications can only be shown by requesting the users to carry out necessary operation, such as downloading and installation, before newly increased applications are used, the process breaks natural experience deserved for the interactive function and is inconsistent to the demand of the interactive function, and the newly increased applications can only be used by requesting the users to carry out installation operation even if a mode of automatically downloading a function module is adopted.

In conclusion, the defect of the prior art is that the interactive function of an operating background configuration can only be used by requiring the users to carry out necessary operation, such as installation, so that poor interactive experience of the users is generated.

### SUMMARY

An embodiment of the present disclosure discloses the framework managing method and framework managing device of the interactive function card of the smart television, aiming at realizing that the interactive function is automatically and fast shown to be used for the users when the installation operation is not carried out on the interactive function by overcoming the defect that the interactive function of the operating background configuration can only be used by requiring the users to carry out necessary operation, such as installation in the prior art, thereby enhancing the interactive experience of the users.

According to one side of the present disclosure, the embodiment of the present disclosure discloses the framework managing method of the interactive function card of the smart television. The framework managing method includes the following steps of: receiving a card update instruction; downloading a new on-line card from a server according to a downloading instruction when the card update instruction is served as the downloading instruction; receiving a card list startup instruction, and starting a card list, wherein the card list includes a plurality of cards, and each card has a corresponding interactive function; receiving a user selection instruction to operate the corresponding cards contained in the card list through a host program.

According to the other side of the present disclosure, the embodiment of the present disclosure also discloses an electronic device for framework managing of an interactive function card, including at least one processor; and a memory communicably connected with the at least one processor for storing instructions executable by the at least one processor, wherein execution of the instructions by the at least one processor causes the at least one processor to: receive the card update instruction; download the new on-line card from a server according to the downloading instruction when the card update instruction is served as the downloading instruction; receive the card list startup instruction and start the card list; the card list includes the plurality of cards, and each card has the corresponding interactive function; receive the user selection instruction to operate the corresponding cards contained in the card list through the host program.

According to another side of the present disclosure, the embodiment of the present disclosure provides a computer program, which includes a computer readable code. When the computer readable code is operated on the smart television, the framework managing method of the interactive function card of the smart television is implemented by the smart television.

According to one more side of the present disclosure, the embodiment of the present disclosure provides a computer readable medium in which the computer program is stored.

The present disclosure has the following beneficial effects:

according to the framework managing method and framework managing device of the interactive function card of the smart television, which are provided by the embodiment of the present disclosure, after the card update instruction is received, when the card update instruction is served as the downloading instruction, the new on-line card (with the interactive function) configured according to an operating strategy of the operating background exists on a server side at the time, the new on-line card is downloaded from the server according to the downloading instruction so as to receive the card list startup instruction, start the card list, receive the user selection instruction and operate the corresponding card contained in the card list through the host program, the card is operated under an uninstalled condition at the time, and the users can normally use the interactive function of the card. Thus, the smart television is capable of temporarily enabling the new card configured according to the operating strategy by the operating background to be on line and capable of automatically and fast showing the interactive function of the card to be used for the users under the condition that the installation operation is not carried out on the card inside the smart television, so that the interactive experience of the users is effectively enhanced.

The illustration is only the summary of the technical scheme of the present disclosure; to more clearly know the technical means of the present disclosure, the implementation is ought to be carried out according to the content of the specification; to enable the above objects, characteristics and advantages and other objects, characteristics and advantages to be more obvious and easily understood, the specific implementation mode of the present disclosure is specially given below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed, wherein:

FIG. 1 is a step flow diagram of the framework managing method of the interactive function card of the smart television of the embodiment of the present disclosure;

FIG. 2 is another step flow diagram of the framework managing method of the interactive function card of the smart television of the embodiment of the present disclosure;

FIG. 3 is a structure diagram of the framework managing device of the interactive function card of the smart television of the embodiment of the present disclosure;

FIG. 4 is another structure diagram of the framework managing device of the interactive function card of the smart television of the embodiment of the present disclosure;

FIG. 5 schematically shows the diagram of an electronic device used for implementing the framework managing method based on the present disclosure;

FIG. 6 schematically shows a storage unit used for maintaining or carrying a program code capable of implementing the method based on the present disclosure.

### DETAILED DESCRIPTION

To make the objective, technical scheme and advantage of the embodiment of the present disclosure clearer, the technical scheme in the embodiment of the present disclosure is clearly and integrally described below combining with the drawings referred to the embodiment of the present disclosure, obviously, the described embodiments are a part of the embodiments of the present disclosure but not all of the embodiments. On the basis of the embodiments of the present disclosure, all other embodiments obtained under the precondition of contributing no creative labor by the ordinary technical personnel in the filed all belong to the range protected by the present disclosure.

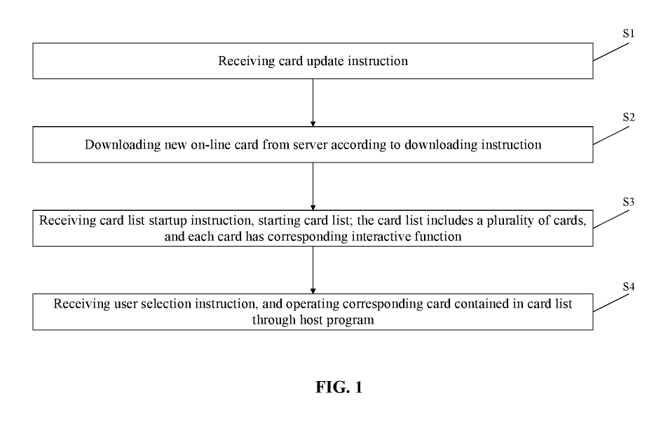

Referring to FIG. 1, one step flow diagram of the framework managing method of the interactive function card of the smart television of the embodiment of the present disclosure is shown.

The framework managing method of the interactive function card of the smart television of the embodiment of the present disclosure includes the steps as follows.

Step S1, receiving the card update instruction.

Wherein the card update instruction can be served as the downloading instruction, a deletion instruction, a card popping instruction and the like.

Step S2, downloading the new on-line card from the server according to the downloading instruction when the card update instruction is served as the downloading instruction.

Particularly, in one embodiment of the present disclosure, the card is a plug-in/APK (Android Package), the new on-line card is downloaded, namely an APK file of the new on-line card is downloaded; particularly, the card is in two states: tape-out (including off-line) and on-line states, wherein the on-line state of the card also depends on modules, the modules include a rotating module, a cable television module, an on-demand module and the like, the card is in the tape-out state when all the modules are tape-out, the card is in the off-line state when all the modules are off-line, and the card is in the on-line state when any one of the modules is on-line.

In addition, the on-line and off-line states of the card can be checked and managing d by the operating background which corresponds to the smart television, the operating background is capable of developing the new card according to the operating strategy, configuring the state of the card and the on-line module of the card and modifying the states of cards contained in an on-line card list inside the server and the on-line module to realize that the on-line card list inside the server is maintained according to the operating strategy of the operating background; wherein when the operating background uploads the developed new card to the server according to the operating strategy, the APK file of the new card needs to be uploaded, information, such as card ID (Identity), card name, brief card introduction, the card on-line module and card sequencing, also needs to be input, then an “on-line” button or icon and the like of the corresponding card are clicked in the on-line card list of the server so that the uploaded card is formally on-line on the server, and the card name, the card ID, a card downloading address and the like can be given by the on-line card; when the operating background modifies the state of the card to be off-line according to the operating strategy, an “off-line” button or icon and the like of the corresponding card are clicked in the on-line card list of the server so that the card is formally off-line on the server; particularly, when the card is on-line or off-line, the server is capable of recording the uploading time, on-line time and off-line time of the card so as to be convenient for the operating background carrying out inquiry and other operations.

Preferably, when the on-line card list inside the server is changed, namely the new on-line card exists in the on-line card list, the server is capable of immediately notifying the smart television by sending the card update instruction, for example, the downloading instruction is sent, the downloading instruction includes new on-line card information, such as the card name and the card ID or the on-line card list; wherein when the downloading instruction includes the new on-line card information, the smart television downloads the corresponding new on-line card from the server according to the downloading instruction, when the downloading instruction includes the on-line card list, the smart television is capable of inquiring the on-line card list, and when the new on-line card which corresponds to the current smart television is found to exist in the on-line card list, the smart television downloads the corresponding new on-line card from the server and is capable of regularly updating the local on-line card list of the smart television.

Step S3, receiving the card list startup instruction, and starting the card list, wherein the card list includes the plurality of cards, and each card has the corresponding interactive function.

Wherein the card list is the card APK, the card APK is capable of showing the interactive function entrance of the card, the users can enter the card through the interactive function entrance of the card so as to use the interactive function of the card; wherein when the card list is started, the card list acquires the cards to be shown from the cards of the smart television and shows the interactive function entrances of the cards to be shown after being started.

Step S4, receiving the user selection instruction, and operating the corresponding card contained in the card list through the host program.

Wherein after the user selection instruction is received, the corresponding card selected by the users in the card list can be operated through the host program contained in an interactive framework SDK (Software Development Kit) of the smart television, and the interactive framework SDK is operated on a preset virtual machine (which is any virtual machine) inside the smart television, so that the user experience is enhanced by realizing that the card can be automatically operated through the preset virtual machine without being installed.

According to a first embodiment of the present disclosure, after the card update instruction is received, when the card update instruction is served as the downloading instruction, the new on-line card (with the interactive function) configured according to an operating strategy of the operating background exists on a server side at the time, the new on-line card is downloaded from the server according to the downloading instruction so as to receive the card list startup instruction, start the card list through the host program, receive the user selection instruction and operate the corresponding card contained in the card list through the host program, the new on-line card is operated under an uninstalled condition at the time, and the users can normally use the interactive function of the new on-line card. Thus, the smart television is capable of temporarily enabling the new card configured according to the operating strategy by the operating background to be on line and capable of automatically and fast showing the interactive function of the card to be used for the users under the condition that the installation operation is not carried out on the card inside the smart television, so that the interactive experience of the users is effectively enhanced.

### Second Embodiment

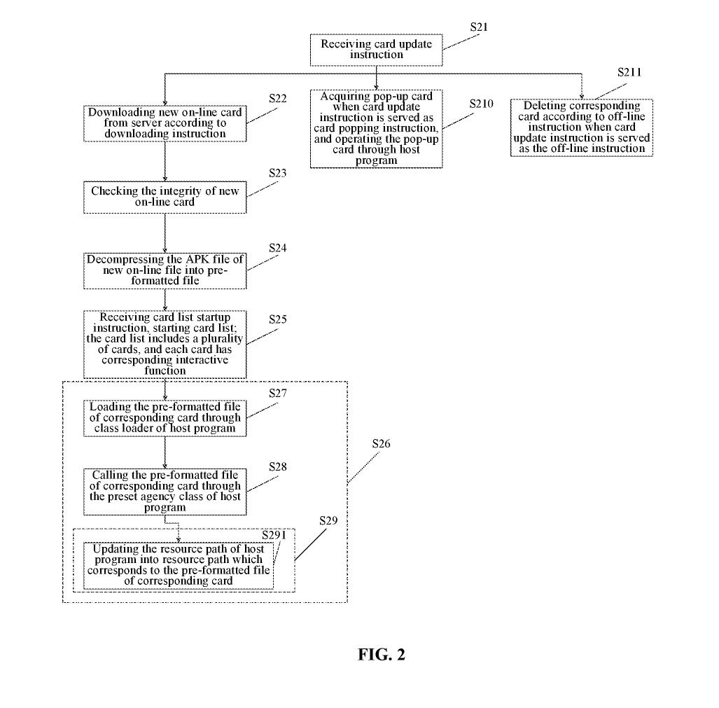

Referring to FIG. 2, another step flow diagram of the framework managing method of the interactive function card of the smart television of the embodiment of the present disclosure is shown. The framework management of the interactive function card of the smart television includes the steps as follows.

Step S21, receiving the card update instruction.

Wherein the card update instruction can be served as the downloading instruction, the deletion instruction, the card popping instruction and the like.

Step S22, downloading the new on-line card from the server according to the downloading instruction when the card update instruction is served as the downloading instruction.

Wherein the step S21 and the step S22 can be executed by the interactive framework SDK inside the smart television; particularly, in one embodiment of the present disclosure, the card is the plug-in/APK, the new on-line card is downloaded, namely the APK file of the new on-line card is downloaded; particularly, the card is in two states: tape-out (including off-line) and on-line states, wherein the on-line state of the card also depends on modules, the modules include the rotating module, the cable television module, the on-demand module and the like, the card is in the tape-out state when all the modules are tape-out, wherein the card is in the off-line state when all the modules are off-line; and the card is in the on-line state when any one of the modules is on-line.

In addition, the on-line and off-line states of the card can be checked and managed by the operating background which corresponds to the smart television, the operating background is capable of developing the new card according to the operating strategy, configuring the state of the card and the on-line module of the card and modifying the states of cards contained in an on-line card list inside the server and the on-line module to realize that the on-line card list inside the server is maintained according to the operating strategy of the operating background; wherein when the operating background uploads the developed new card to the server according to the operating strategy, the APK file of the new card needs to be uploaded, information, such as the card ID, the card name, the brief card introduction, the card on-line module and card sequencing, also needs to be input, then the “on-line” button or icon and the like of the corresponding card are clicked in the on-line card list of the server so that the uploaded card is formally on-line on the server, and the card name, the card ID, the card downloading address and the like can be given by the on-line card; when the operating background modifies the state of the card to be off-line according to the operating strategy, the “off-line” button or icon and the like of the corresponding card are clicked in the on-line card list of the server so that the card is formally off-line on the server; particularly, when the card is on-line or off-line, the server is capable of recording the uploading time, on-line time and off-line time of the card so as to be convenient for the operating background carrying out inquiry and other operations.

Preferably, when the on-line card list inside the server is changed, namely the new on-line card exists in the on-line card list, the server is capable of immediately notifying the interactive framework SDK by sending the card update instruction, for example, the downloading instruction is sent, the downloading instruction includes new on-line card information, such as the card name and the card ID or the on-line card list; wherein when the downloading instruction includes the new on-line card information, the interactive framework SDK is capable of downloading the corresponding new on-line card from the server according to the downloading instruction, when the downloading instruction includes the on-line card list, the interactive framework SDK is capable of inquiring the on-line card list contained in the downloading instruction, and when the new on-line card which corresponds to the current smart television is found to exist in the on-line card list, the interactive framework SDK is capable of downloading the corresponding new on-line card from the server and capable of regularly updating the local on-line card list of the smart television.

What need to note is that the new on-line card of the server includes a resident card and a pop-up card; the resident card can be called by the users actively from the card list and provide the usage of the interactive function for the users in the program viewing process of the users; the pop-up card is popped up in the program viewing process of the users, and the pop-up card is popped up through the push information of the server, so that the appearance time of the pop-up card on the screen of the smart television can be flexibly configured by the operating background according to the operating strategy; wherein a plurality of resident cards can not only be automatically popped up, but also be called by the users at any time to be viewed or provide the usage of the interactive function for the users; in the step S23, when the card update instruction is served as the downloading instruction, the new on-line resident card is downloaded from the server according to the downloading instruction.

Step S23, checking the integrity of the new on-line card.

Wherein the MD5 value of the APK file of the new on-line card can be checked through the interactive framework SDK to determine whether the APK file of the new on-line card is mistaken or tampered or not, so that the integration of the downloaded APK file is ensured.

Step S24, decompressing the APK file of the new on-line card into a pre-formatted file.

A preset format can be a dex format or other formats capable of being operated by the preset virtual machine (which is any virtual machine) inside the smart television; wherein the step S24 can be executed by the interactive framework SDK inside the smart television.

S25, receiving the card list startup instruction, starting the card list; wherein the card list includes the plurality of cards, and each card has the corresponding interactive function.

Wherein the card list is the card APK, the card APK is capable of showing the interactive function entrance of the card, the users can enter the card through the interactive function entrance of the card so as to use the interactive function of the card; wherein in the step S25, after the card list startup instruction is received, the card list can be started through the host program contained in the interactive framework SDK so as to realize that the card list can be automatically operated through the virtual machine without being installed; when the card list is started, the card list acquires the cards to be shown from the cards of the smart television and shows the interactive function entrances of the cards to be shown after being started; and the users can enter the corresponding card by selecting any interactive function entrance.

In addition, according to a module of a program currently viewed by the users, the card list is capable of showing the interactive function entrances of different cards according to the attribute information (including on-line modules of the cards and the like) of the cards; for example, the card list includes an A card, a B card and a C card, wherein the rotating module, the cable television module and the on-demand module are served as the on-line module of the A card, the rotating module and the cable television module are served as the on-line module of the B card, and the on-demand module is served as the on-line module of the C card; when the program currently viewed by the users is on the rotating module or the cable television module, the card list shows the interactive function entrances of the A card and the B card; when the program currently viewed by the users is on the on-demand module, the card list shows the interactive function entrances of the A card and the C card.

Step S26, receiving the user selection instruction, operating the corresponding card contained in the card list through the host program, including:

step S27, loading the pre-formatted file of the corresponding card through a class loader contained in the host program.

Wherein when the preset format is the dex format, the class loader can be in a dexClassLoader class, and the step S24 is carried out before the step S27.

Step S28, calling the pre-formatted file of the corresponding card through a preset agency class contained in the host program.

wherein an agency class DLProxyActivity can be realized in the host program, when the pre-formatted file of the corresponding card is called through the preset agency class contained in the host program, a code contained in the pre-formatted file is necessary to inherit the agency class DLProxyActivity; the code contained in the pre-formatted file is necessary to realize a specific method contained in the agency class DLProxyActivity, thus, when the pre-formatted file of the corresponding card is called through the preset agency class contained in the host program, the agency class DLProxyActivity is capable of replacing the method contained in the code contained in the pre-formatted file; and therefore the agency class DLProxyActivity of the host program is actually called when the pre-formatted file is called by the agency class DLProxyActivity.

Step S29, operating the host program through the preset virtual machine.

Particularly, because the agency class DLProxyActivity is a shell, when the pre-formatted file is called by the agency class DLProxyActivity, the code actually operated by the virtual machine is the code contained in the pre-formatted file so as to realize that the card can be automatically operated without being installed.

Wherein, the step 29 is that the host program is operated through the preset virtual machine, including:

step S291, updating a resource path of the host program into the resource path which corresponds to the pre-formatted file of the corresponding card.

In the step S291, an object actually operated by the virtual machine is not the self pre-formatted file, namely the context of the object actually operated by the virtual machine is the context of the agency class DLProxyActivity, thus, the virtual machine is incapable of directly accessing the resource (such as a picture, a text and the like) path which corresponds to the code contained in the pre-formatted file, and the virtual machine is capable of accessing a resource which corresponds to the code contained in the pre-formatted file after the resource path of the host program is updated into the resource path which corresponds to the pre-formatted file through the step S291.

Wherein the resource path of the host program can be updated into the resource path which corresponds to the pre-formatted file by adopting a reflection technology in the step S291, and a part of program codes which correspond to a specific method are as follows:
AssetManager assetManager=AssetManager.class.newInstance( );
Method addAssetPath=assetManager.getClass( ).getMethod(“addAssetPath”, String.class);
   addAssetPath.invoke(assetManager, dexPath);

The program codes are used for establishing an AssetManager object according to the resource path which corresponds to the pre-formatted file and adding the resource path which corresponds to the pre-formatted file to the AssetManager object.

In addition, after the program codes are operated, a Resources object can be established through the AssetManager object, the Resources object is a resource object which corresponds to the pre-formatted file, and the virtual machine is capable of accessing the resource which corresponds to the code contained in the pre-formatted file through the Resources object, so that no difference exists between that the users use the interactive function of the card after the host program is operated by the virtual machine and that the users use the interactive function of the card after the card is installed in the smart television.

Step S210, when the card update instruction is served as the card popping instruction, acquiring the pop-up card and operating the pop-up card through the host program.

Wherein in the step S210, when the card update instruction is served as the card popping instruction, the push information of the server includes card popping, so that the pop-up card can be directly acquired; particularly, the integrity of the pop-up card can be checked and the APK file of the pop-up card can be decompressed into the pre-formatted file before the pop-up card is operated through the host program in the step S210, and the operation of the pop-up card is realized through the step S27, the step S28 and the step S29.

Step S211, when the card update instruction is served as an off-line instruction, deleting the corresponding card according to the off-line instruction.

Wherein when the card is formally off-line on the server, the server is capable of immediately notifying the interactive framework SDK inside the smart television by sending the card update instruction, for example, the deletion instruction is sent, the deletion instruction includes off-line card information, such as the card name and the card ID, and the interactive framework SDK is capable of deleting the corresponding card contained in the card list according to the deletion instruction so as to realize that the interactive card can be flexibly off-line according to the operating strategy of the operating background; wherein the deletion of the corresponding card contained in the card list can be equivalent to the deletion of the APK file of the corresponding card.

Particularly, when the card list is started in the step S25, the interactive framework SDK inside the smart television is capable of managing the interface presentation logic; wherein before the interface presentation of the card list is carried out, the interactive framework SDK firstly determines the module of the program currently viewed by the users and then acquires current program information through broadcast interfaces of the interactive framework SDK with the modules (the rotating module, the cable television module, the on-demand module and the like) and synchronizing module information and the current program information to the resident cards contained in the card list, and the pop-up card is filtered by the interactive framework SDK, the card list shows the interaction functions of different resident cards according to the module information and the module authority of the resident cards to enable the users to know that the interactive functions, which are shown by the card list, of the resident cards are relevant to the currently viewed program, so that the interactive experience of the users is enhanced; in addition, the pop-up card can be operated through the host program of the interactive framework SDK, the interactive function of the pop-up card is directly and automatically shown on the smart television, so that the users can further operate the pop-up card without installing the pop-up card, and the user experience is enhanced.

According to the second embodiment of the present disclosure, after the card update instruction is received, when the card update instruction is served as the downloading instruction, the new on-line resident card (with the interactive function) configured according to the operating strategy of the operating background exists in the server at the time, and the new on-line resident card is downloaded from the server according to the downloading instruction; after the integrity of the new on-line resident card is checked through the MD5 value, the APK file of the new on-line resident card is decompressed into the pre-formatted file, such as a dex format file, after the card list startup instruction is received, the card list is started, and after the user selection instruction is received, the pre-formatted file of the corresponding card is loaded through the class loader contained in the host program, the pre-formatted file of the corresponding card is called through the preset agency class contained in the host program, the host program is operated through the preset virtual machine, the card is operated under the uninstalled condition at the time, and the users can normally use the interactive function of the card; when the card update instruction is served as the card popping instruction, the pop-up card is acquired, the pop-up card is operated through the host program, and the appearance time of the pop-up card on the screen of the smart television can be flexibly configured by the operating background according to the operating strategy; when the card update instruction is served as the off-line instruction, the corresponding card is deleted according to the off-line instruction; thus, the smart television is capable of temporarily enabling a new resident card configured by the operating strategy of the operating background to be on line, showing the pop-up card configured by the operating background according to the operating strategy, enabling the cards (including the resident card and the pop-up card) configured by the operating background according to the operating strategy to be off line and automatically and fast showing the interactive functions of the cards under the condition that the installation operation is not carried out on the cards to be used by the users, so that the interactive experience of the users is effectively enhanced.

### Third Embodiment

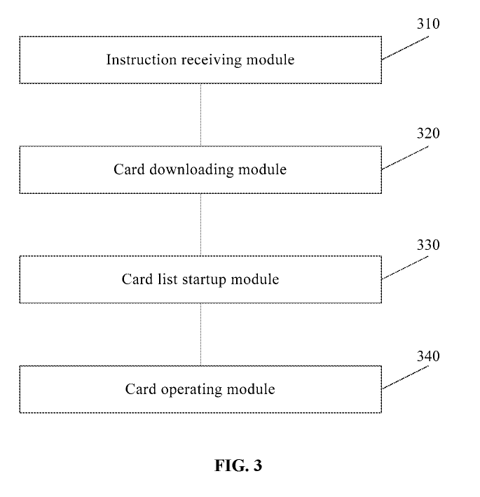

Referring to FIG. 3, the structure diagram of the framework managing device of the interactive function card of the smart television of the third embodiment of the present disclosure.

The framework managing device of the interactive function card of the smart television of the embodiment of the present disclosure includes:

an instruction receiving module 310 used for receiving the card update instruction,

wherein the card update instruction includes the downloading instruction, the deletion instruction, the card popping instruction and the like;

a card downloading module 320 used for downloading the new on-line card from the server according to the downloading instruction when the card update instruction is served as the downloading instruction.

Particularly, in one embodiment of the present disclosure, the card is the plug-in/APK (Android Package), the new on-line card is downloaded through the card downloading module 320, namely the APK file of the new on-line card is downloaded; particularly, the card is in two states: tape-out (including off-line) and on-line states, wherein the on-line state of the card also depends on the modules, the modules include the rotating module, the cable television module, the on-demand module and the like, the card is in the tape-out state when all the modules are tape-out, the card is in the off-line state when all the modules are off-line, and the card is in the on-line state when any one of the modules is on-line.

In addition, the on-line and off-line states of the card can be checked and managed by the operating background which corresponds to the smart television, the operating background is capable of developing the new card according to the operating strategy, configuring the state of the card and the on-line module of the card and modifying the states of cards contained in the on-line card list inside the server and the on-line module to realize that the on-line card list inside the server is maintained according to the operating strategy of the operating background; wherein when the operating background uploads the developed new card to the server according to the operating strategy, the APK file of the new card needs to be uploaded, information, such as card ID (Identity), card name, brief card introduction, the card on-line module and card sequencing, also needs to be input, then an “on-line” button or icon and the like of the corresponding card are clicked in the on-line card list of the server so that the uploaded card is formally on-line on the server, and the card name, the card ID, the card downloading address and the like can be given by the on-line card; when the operating background modifies the state of the card to be off-line according to the operating strategy, the “off-line” button or icon and the like of the corresponding card are clicked in the on-line card list of the server so that the card is formally off-line on the server; particularly, when the card is on-line or off-line, the server is capable of recording the uploading time, on-line time and off-line time of the card so as to be convenient for the operating background carrying out inquiry and other operations.

Preferably, when the on-line card list inside the server is changed, namely the new on-line card exists in the on-line card list, the server is capable of immediately notifying the smart television by sending the card update instruction, for example, the downloading instruction is sent, the downloading instruction includes new on-line card information, such as the card name and the card ID or the on-line card list; wherein when the downloading instruction includes the new on-line card information, the card downloading module 320 downloads the corresponding new on-line card from the server according to the downloading instruction, when the downloading instruction includes the on-line card list, the card downloading module 320 is capable of inquiring the on-line card list, and when the new on-line card which corresponds to the current smart television is found to exist in the on-line card list, the card downloading module 320 downloads the corresponding new on-line card from the server and is capable of regularly updating the local on-line card list of the smart television.

A card list startup module 330 may also be included, which is used for receiving the card list startup instruction and starting the card list, wherein the card list includes the plurality of cards, and each card has the corresponding interactive function.

Wherein the card list is the card APK, the card APK is capable of showing the interactive function entrance of the card, the users can enter the card through the interactive function entrance of the card so as to use the interactive function of the card; wherein when the card list is started, the card list acquires the cards to be shown from the cards of the smart television and shows the interactive function entrances of the cards to be shown after being started;

A card operating module 340 may also be included, which is used for receiving the user selection instruction and operating the corresponding card contained in the card list through the host program.

Wherein after the card operating module 340 receives the user selection instruction, the corresponding card selected by the users in the card list can be operated through the host program contained in the interactive framework SDK of the smart television by the card operating module 340, and the interactive framework SDK is operated on the preset virtual machine (which is any virtual machine) inside the smart television, so that the user experience is enhanced by realizing that the card can be automatically operated through the preset virtual machine without being installed.

According to a third embodiment of the present disclosure, after the instruction receiving module receives the card update instruction, when the card update instruction is served as the downloading instruction, the new on-line card (with the interactive function) configured according to an operating strategy of the operating background exists on a server side at the time, the new on-line card is downloaded from the server according to the downloading instruction by the card downloading module, the card list startup module receives the card list startup instruction and is capable of starting the card list through the host program, the card operating module receives the user selection instruction and operates the corresponding card contained in the card list through the host program, the new on-line card is operated under an uninstalled condition at the time, and the users can normally use the interactive function of the new on-line card. Thus, the smart television is capable of temporarily enabling the new card configured according to the operating strategy by the operating background to be on line and capable of automatically and fast showing the interactive function of the card to be used for the users under the condition that the installation operation is not carried out on the card inside the smart television, so that the interactive experience of the users is effectively enhanced.

### Fourth Embodiment

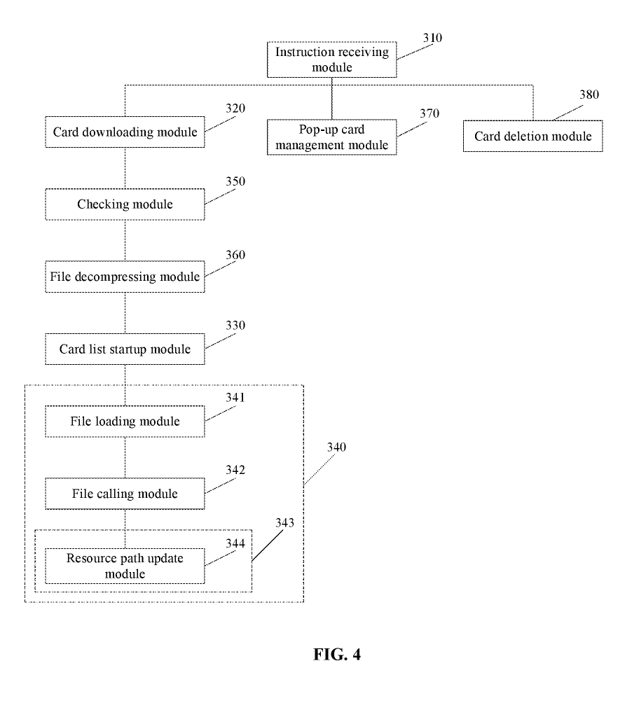

Referring to FIG. 4, another structure diagram of the framework managing device of the interactive function card of the smart television of the fourth embodiment of the present disclosure is shown. The framework managing device of the interactive function card of the smart television includes the modules as follows.

The instruction receiving module 310 used for receiving the card update instruction, wherein the card update instruction includes the downloading instruction, the deletion instruction, the card popping instruction and the like.

The card downloading module 320 used for downloading the new on-line card from the server according to the downloading instruction when the card update instruction is served as the downloading instruction, wherein the instruction receiving module 310 and the card downloading module 320 can be arranged in the interactive framework SDK inside the smart television; particularly, in one embodiment of the present disclosure, the card is the plug-in/APK, the new on-line card is downloaded by the card downloading module 320, namely the APK file of the new on-line card is downloaded; particularly, the card is in two states: tape-out (including off-line) and on-line states, wherein the on-line state of the card also depends on the modules, the modules include the rotating module, the cable television module, the on-demand module and the like, the card is in the tape-out state when all the modules are tape-out, wherein the card is in the off-line state when all the modules are off-line; and the card is in the on-line state when any one of the modules is on-line.

In addition, the on-line and off-line states of the card can be checked and managing d by the operating background which corresponds to the smart television, the operating background is capable of developing the new card according to the operating strategy, configuring the state of the card and the on-line module of the card and modifying the states of cards contained in an on-line card list inside the server and the on-line module to realize that the on-line card list inside the server is maintained according to the operating strategy of the operating background; wherein when the operating background uploads the developed new card to the server according to the operating strategy, the APK file of the new card needs to be uploaded, information, such as card ID, card name, brief card introduction, the card on-line module and card sequencing, also needs to be input, then an “on-line” button or icon and the like of the corresponding card are clicked in the on-line card list of the server so that the uploaded card is formally on-line on the server, and the card name, the card ID, a card downloading address and the like can be given by the on-line card; when the operating background modifies the state of the card to be off-line according to the operating strategy, an “off-line” button or icon and the like of the corresponding card are clicked in the on-line card list of the server so that the card is formally off-line on the server; particularly, when the card is on-line or off-line, the server is capable of recording the uploading time, on-line time and off-line time of the card so as to be convenient for the operating background carrying out inquiry and other operations.

Preferably, when the on-line card list inside the server is changed, namely the new on-line card exists in the on-line card list, the server is capable of immediately notifying the interactive framework SDK by sending the card update instruction, for example, the downloading instruction is sent, the downloading instruction includes the new on-line card information, such as the card name and the card ID or the on-line card list; wherein when the downloading instruction includes the new on-line card information, the card downloading module 320 is capable of downloading the corresponding new on-line card from the server according to the downloading instruction, when the downloading instruction includes the on-line card list, the card downloading module 320 is capable of inquiring the on-line card list contained in the downloading instruction, and when the new on-line card which corresponds to the current smart television is found to exist in the on-line card list, the card downloading module 320 is capable of downloading the corresponding new on-line card from the server and capable of regularly updating the local on-line card list of the smart television.

What need to note is that the new on-line card of the server includes a resident card and a pop-up card; the resident card can be called by the users actively from the card list and provide the usage of the interactive function for the users in the program viewing process of the users; the pop-up card is popped up in the program viewing process of the users, and the pop-up card is popped up through the push information of the server, so that the appearance time of the pop-up card on the screen of the smart television can be flexibly configured by the operating background according to the operating strategy; wherein a plurality of resident cards can not only be automatically popped up, but also be called by the users at any time to be viewed or provide the usage of the interactive function for the users; when the card update instruction is served as the downloading instruction, the new on-line resident card is downloaded from the server according to the downloading instruction by the card downloading module 320.

A checking module 350 may further be included, which is used for checking the integrity of the new on-line card after the new on-line card is downloaded from the server according to the downloading instruction by the card downloading module 320,

wherein the checking module 350 is capable of checking the MD5 value of the APK file of the new on-line card to determine whether the APK file of the new on-line card is mistaken or tampered or not so as to ensure the integrity of the downloaded APK file; the checking module 350 can be arranged in the interactive framework SDK.

A file decompressing module 360 may also be included, which is used for decompressing the APK file of the new on-line card into the pre-formatted file.

The preset format can be the dex format or other formats capable of being operated by the preset virtual machine (which is any virtual machine) inside the smart television, wherein the file decompressing module 360 can be arranged in the interactive framework SDK;

A card list startup module 330 may also be included, which is used for receiving the card list startup instruction and starting the card list, wherein the card list includes the plurality of cards, and each card has the corresponding interactive function.

Wherein the card list is the card APK, the card APK is capable of showing the interactive function entrance of the card, the users can enter the card through the interactive function entrance of the card so as to use the interactive function of the card; wherein after the card list startup instruction is received, the card list can be started through the host program contained in the interactive framework SDK by the card list startup module 330 so as to realize that the card list can be automatically operated through the virtual machine without being installed; when the card list is started, the card list acquires the cards to be shown from the cards of the smart television and shows the interactive function entrances of the cards to be shown after being started; and the users can enter the corresponding card by selecting any interactive function entrance.

In addition, according to a module of a program currently viewed by the users, the card list is capable of showing the interactive function entrances of different cards according to the attribute information (including on-line modules of the cards and the like) of the cards; for example, the card list includes an A card, a B card and a C card, wherein the rotating module, the cable television module and the on-demand module are served as the on-line module of the A card, the rotating module and the cable television module are served as the on-line module of the B card, and the on-demand module is served as the on-line module of the C card; when the program currently viewed by the users is on the rotating module or the cable television module, the card list shows the interactive function entrances of the A card and the B card; when the program currently viewed by the users is on the on-demand module, the card list shows the interactive function entrances of the A card and the C card.

The card operating module 340 used for receiving the user selection instruction and operating the corresponding card contained in the card list through the host program, including:

a file loading module 341 used for loading the pre-formatted file of the corresponding card through the class loader contained in the host program,

wherein when the preset format is the dex format, the class loader can be the dexClassLoader class; particularly, the file decompressing module 360 is ought to be at front of the file loading module 341;

a file calling module 342 used for calling the pre-formatted file of the corresponding card through the preset agency class contained in the host program,

wherein an agency class DLProxyActivity can be realized in the host program, when the pre-formatted file of the corresponding card is called through the preset agency class contained in the host program by the file calling module 342, the code contained in the pre-formatted file is necessary to inherit the agency class DLProxyActivity; the code contained in the pre-formatted file is necessary to realize the specific method contained in the agency class DLProxyActivity, thus, when the pre-formatted file of the corresponding card is called through the preset agency class contained in the host program by the file calling module 342, the agency class DLProxyActivity is capable of replacing the method contained in the code contained in the pre-formatted file; and therefore the agency class DLProxyActivity of the host program is actually called when the pre-formatted file is called by the agency class DLProxyActivity;

a program operating module 343 used for operating the host program through the preset virtual machine.

Particularly, because the agency class DLProxyActivity is the shell, when the pre-formatted file is called by the agency class DLProxyActivity, the code actually operated by the virtual machine is the code contained in the pre-formatted file so as to realize that the card can be automatically operated without being installed.

Wherein the program operating module 343 includes:

a resource path update module 344 used for updating the resource path of the host program into the resource path which corresponds to the pre-formatted file of the corresponding card.

In the resource path update module 344, the object actually operated by the virtual machine is not the self pre-formatted file, namely the context of the object actually operated by the virtual machine is the context of the agency class DLProxyActivity, thus, the virtual machine is incapable of directly accessing the resource (such as a picture, a text and the like) path which corresponds to the code contained in the pre-formatted file, and the virtual machine is capable of accessing a resource which corresponds to the code contained in the pre-formatted file after the resource path of the host program is updated into the resource path which corresponds to the pre-formatted file through the resource path update module.

Wherein the resource path of the host program can be updated into the resource path which corresponds to the pre-formatted file by adopting the reflection technology by the resource path update module 344, and a part of the program codes which correspond to the specific method are as follows:
AssetManager assetManager=AssetManager.class.newInstance( );
Method addAssetPath=assetManager.getClass( ).getMethod(“addAssetPath”, String.class);
   addAssetPath.invoke(assetManager, dexPath);
the program codes are used for establishing the AssetManager object according to the resource path which corresponds to the pre-formatted file and adding the resource path which corresponds to the pre-formatted file to the AssetManager object.

In addition, after the program codes are operated, a Resources object can be established through the AssetManager object, the Resources object is a resource object which corresponds to the pre-formatted file, and the virtual machine is capable of accessing the resource which corresponds to the code contained in the pre-formatted file through the Resources object, so that no difference exists between that the users use the interactive function of the card after the host program is operated by the virtual machine and that the users use the interactive function of the card after the card is installed in the smart television.

A pop-up card management module 370 may also be included, which is used for acquiring the pop-up card and operating the pop-up card through the host program when the card update instruction is served as the card popping instruction.

Wherein, when the card update instruction is served as the card popping instruction, the push information of the server includes the card popping, so that the pop-up card can be directly acquired by the pop-up card management module 370; particularly, the integrity of the pop-up card can be checked through the checking module 350 and the APK file of the pop-up card can be decompressed into the pre-formatted file through the file decompressing module 360 before the pop-up card is operated through the host program by the pop-up card management module 370, and the operation of the pop-up card is realized through the file loading module 341, the file calling module 342 and the program operating module 343.

A card deletion module 380 may also be included, which is used for deleting the corresponding card according to the off-line instruction when the card update instruction is served as the off-line instruction.

Wherein when the card is formally off-line on the server, the server is capable of immediately notifying the interactive framework SDK inside the smart television by sending the card update instruction, for example, the deletion instruction is sent, the deletion instruction includes off-line card information, such as the card name and the card ID, and the card deletion module 380 is capable of deleting the corresponding card contained in the card list according to the deletion instruction so as to realize that the interactive card can be flexibly off-line according to the operating strategy of the operating background; wherein the deletion of the corresponding card contained in the card list can be equivalent to the deletion of the APK file of the corresponding card.

Particularly, when the card list is started by the card list startup module 330, the interactive framework SDK inside the smart television is capable of managing the interface presentation logic; wherein before the interface presentation of the card list is carried out, the interactive framework SDK firstly determines the module of the program currently viewed by the users and then acquires current program information through broadcast interfaces of the interactive framework SDK with the modules (the rotating module, the cable television module, the on-demand module and the like) and synchronizing module information and the current program information to the resident cards contained in the card list, and the pop-up card is filtered by the interactive framework SDK, the card list shows the interaction functions of different resident cards according to the module information and the module authority of the resident cards to enable the users to know that the interactive functions, which are shown by the card list, of the resident cards are relevant to the currently viewed program, so that the interactive experience of the users is enhanced; in addition, the pop-up card can be operated through the host program of the interactive framework SDK, the interactive function of the pop-up card is directly and automatically shown on the smart television, so that the users can further operate the pop-up card without installing the pop-up card, and the user experience is enhanced.

According to the fourth embodiment of the present disclosure, after the instruction receiving module receives the card update instruction, when the card update instruction is served as the downloading instruction, the new on-line resident card (with the interactive function) configured according to an operating strategy of the operating background exists on the server at the time, and the new on-line resident card is downloaded from the server according to the downloading instruction by the card downloading module; after the integrity of the new on-line resident card is checked through the MD5 value by the checking module, the APK file of the new on-line resident card is decompressed into the pre-formatted file, such as the dex format file, by the file decompressing module; after the card list startup instruction is received, the card list is started by the card list startup module; after the user selection instruction is received by the card operating module, the pre-formatted file of the corresponding card is loaded through the class loader contained in the host program by the file loading module, the pre-formatted file of the corresponding card is called through the preset agency class contained in the host program by the file calling module, the host program is operated through the preset virtual machine by the program operating module, the card is operated under the uninstalled condition at the time, and the users can normally use the interactive function of the card; when the card update instruction is served as the card popping instruction, the pop-up card is acquired by the pop-up card management module, the pop-up card is operated through the host program, and the appearance time of the pop-up card on the screen of the smart television can be flexibly configured by the operating background according to the operating strategy; when the card update instruction is served as the off-line instruction, the corresponding card is deleted according to the off-line instruction by the card deletion module; thus, the smart television is capable of temporarily enabling the new resident card configured by the operating strategy of the operating background to be on line, showing the pop-up card configured by the operating background according to the operating strategy, enabling the cards (including the resident card and the pop-up card) configured by the operating background according to the operating strategy to be off line and automatically and fast showing the interactive functions of the cards under the condition that the installation operation is not carried out on the cards to be used by the users, so that the interactive experience of the users is effectively enhanced.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

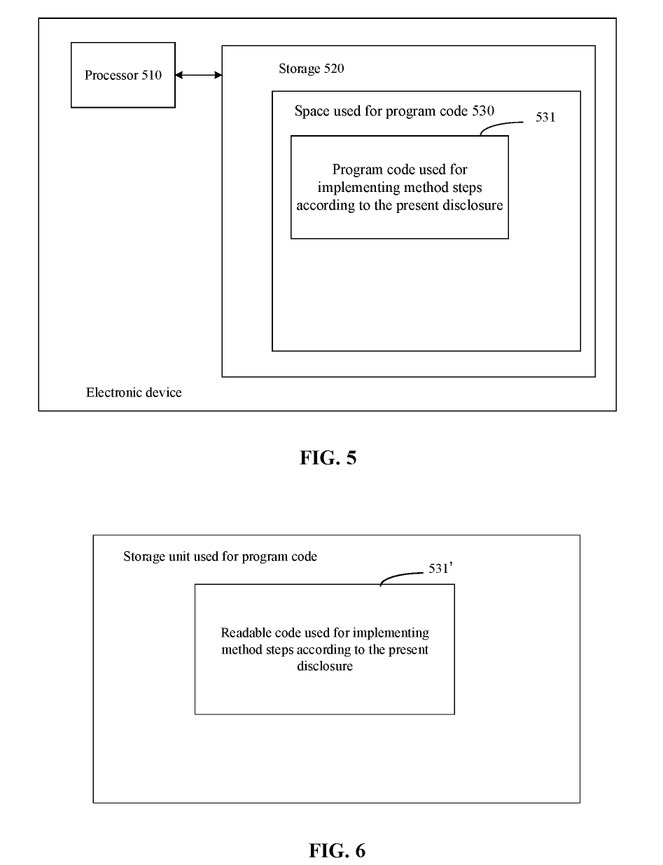

For example, FIG. 5 illustrates a block diagram of an electronic device for executing the method according the disclosure. The electronic device may be the smart Television above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

What need to finally note is that the embodiments are only used for illustrating the technical scheme but not limit the technical scheme; even though the present disclosure is illustrated in a detailed manner referring to the embodiments, ordinary technical personnel in the field should understand: the ordinary technical personnel can still modify the technical scheme recorded in the embodiments or equally replace a part of technical characteristics of the technical scheme; and the essence of the corresponding technical scheme cannot be separated from the spirit and range of the technical schemes of the embodiments of the present disclosure due to the modification or replacement.

What is claimed is:

1. A framework managing method of an interactive function card of a smart television, comprising:
receiving a card update instruction;
downloading a new on-line card from a server according to a downloading instruction when the card update instruction is the downloading instruction;
receiving a card list startup instruction, starting a card list; wherein the card list comprises a plurality of cards, and each card has a corresponding interactive function;
receiving a user selection instruction, and operating the corresponding card in the card list through a host program.

2. The method according to claim 1, further comprising:
decompressing an APK file of the new on-line card into a pre-formatted file.

3. The method according to claim 2, wherein operating the corresponding card in the card list through the host program, comprising:
loading a pre-formatted file of the corresponding card through a class loader in the host program;
calling the pre-formatted file of the corresponding card through a preset agency class contained in the host program;
operating the host program through a preset virtual machine.

4. The method according to claim 3, wherein operating the host program through the preset virtual machine, comprising:
updating a resource path of the host program into a resource path which corresponds to the pre-formatted file of the corresponding card.

5. The method according to claim 1, further comprising:
deleting the corresponding card according to an off-line instruction when the card update instruction is the off-line instruction.

6. The method according to claim 1, further comprising:
acquiring a pop-up card, and operating the pop-up card through the host program when the card update instruction is a card popping instruction.

7. The method according to claim 1, wherein after the new on-line card is downloaded from the server according to the downloading instruction, the method further comprises: checking the integrity of the new on-line card.

8. An electronic device, comprising:
at least one processor; and
a memory communicably connected with the at least one processor for storing instructions executable by the at least one processor, wherein execution of the instructions by the at least one processor causes the at least one processor to:
receive a card update instruction;
download a new on-line card from a server according to a downloading instruction when the card update instruction is the downloading instruction;
receive a card list startup instruction and start a card list, wherein the card list comprises a plurality of cards, and each card has corresponding interactive function;
receive a user selection instruction and operate the corresponding card in the card list through a host program.

9. The electronic device according to claim 8, wherein execution of the instructions by the at least one processor causes the at least one processor to further:
decompress an APK file of the new on-line card into a pre-formatted file.

10. The electronic device according to claim 9, wherein receive a user selection instruction and operate the corresponding card in the card list through a host program comprises:
load the pre-formatted file of the corresponding card through a class loader in the host program;
call the pre-formatted file of the corresponding card through a preset agency class contained in the host program;
operate the host program through a preset virtual machine.

11. The electronic device according to the claim 10, wherein operate the host program through a preset virtual machine comprises:
update a resource path of the host program into a resource path which corresponds to the pre-formatted file of the corresponding card.

12. The electronic device according to claim 8, wherein execution of the instructions by the at least one processor causes the at least one processor to further:
delete the corresponding card according to an off-line instruction when the card update instruction is the off-line instruction.

13. The electronic device according to claim 8, wherein execution of the instructions by the at least one processor causes the at least one processor to further:
acquire a pop-up card when the card update instruction is a card popping instruction and operate the pop-up card through the host program.

14. The electronic device according to claim 8, wherein execution of the instructions by the at least one processor causes the at least one processor to further:
check the integrity of the new on-line card after the new on-line card is downloaded from the server according to the downloading instruction by the card downloading module.

15. A non-transitory computer readable medium storing executable instructions that, when executed by an electronic device, cause the electronic device to:
receive a card update instruction;
download a new on-line card from a server according to a downloading instruction when the card update instruction is the downloading instruction;
receive a card list startup instruction, start a card list; wherein the card list comprises a plurality of cards, and each card has a corresponding interactive function;
receive a user selection instruction, and operate the corresponding card in the card list through a host program.

16. The non-transitory computer readable medium according to claim 15, wherein the electronic device is further caused to:
decompress an APK file of the new on-line card into a pre-formatted file.

17. The non-transitory computer readable medium according to claim 16, wherein receive a user selection instruction and operate the corresponding card in the card list through a host program comprises:
load the pre-formatted file of the corresponding card through a class loader in the host program;
call the pre-formatted file of the corresponding card through a preset agency class contained in the host program;
operate the host program through a preset virtual machine.

18. The non-transitory computer readable medium according to claim 15, wherein the electronic device is further caused to:
delete the corresponding card according to an off-line instruction when the card update instruction is the off-line instruction.

19. The non-transitory computer readable medium according to claim 15, wherein the electronic device is further caused to:
acquire a pop-up card when the card update instruction is a card popping instruction and operate the pop-up card through the host program.

20. The non-transitory computer readable medium according to claim 15, wherein the electronic device is further caused to:
check the integrity of the new on-line card after the new on-line card is downloaded from the server according to the downloading instruction by the card downloading module.
